(19) United States
(12) Patent Application Publication
(10) Pub. No.: US 2013/0178961 A1
(43) Pub. Date: Jul. 11, 2013

(54) FACILITATING PERSONAL AUDIO PRODUCTIONS

(71) Applicants: Anh Q. Ly, New York, NY (US); William Lawrence Portnoy, Woodinville, WA (US); Richard Daniel Marshall, Lynnwood, WA (US); Gregory Scott Melander, Renton, WA (US)

(72) Inventors: Anh Q. Ly, New York, NY (US); William Lawrence Portnoy, Woodinville, WA (US); Richard Daniel Marshall, Lynnwood, WA (US); Gregory Scott Melander, Renton, WA (US)

(73) Assignee: MICROSOFT CORPORATION, Redmond, WA (US)

(21) Appl. No.: 13/343,720

(22) Filed: Jan. 5, 2012

(51) Int. Cl. G06F 17/00; G06F 3/00

(52) U.S. Cl. 700/94; 715/716

(57) ABSTRACT

Techniques for facilitating personal audio productions, such as verbalized recordings of stories. One representative technique includes a computer-implemented method, including presenting recording prompts each suggestive of a response topic. Spoken audio segments are stored in response to respective ones of the recording prompts. The spoken audio segments may thereafter be assembled into a unitary audio file for transmission.

### BACKGROUND

Personal audio recordings of years past were traditionally created on devices that recorded on physical media, such as magnetic media. People may have created personal recordings for archival or other purposes, but disseminating such recordings could be difficult as physical recording duplicates may have been required. For some purposes, the limitations of transferable physical media might be prohibitive. For example, it would be unlikely, if not impossible, for daily audio recordings to be made for same-day distribution and consumption.

With the advent of computing devices with communication capabilities, a recording could be made, saved on a computer, and possibly transferred to another device. However, the technical ability to simply record and transfer audio does not assist the user beyond preserving the spoken words. Speakers may be uncomfortable with creating an open-ended verbal recording, and may be uncertain as to how to present their stories or other verbal presentations. Additionally, it may be difficult for the casual user to create a professional production, or to share such stories with targeted audiences. These and other issues may significantly limit people's willingness to record their stories, and ultimately discourage passing down or otherwise disseminating history, knowledge, local lore and similar information.

### SUMMARY

Techniques for facilitating personal audio productions, such as verbalized stories. One representative technique includes a computer-implemented method, including presenting, via a user interface, recording prompts each suggestive of a response topic. Spoken audio segments are stored in response to respective ones of the recording prompts. The spoken audio segments may thereafter be assembled into a unitary audio file.

Another representative embodiment is directed to an apparatus that includes at least a processor, storage, and application programming interface (API). In this embodiment, the processor is configured to provide story topics to device users. The storage is configured to store at least audio stories relating to the story topic and recorded by the device users. The API is configured to enable access to the stored audio stories by third party applications.

Another representative embodiment is directed to computer-readable media having instructions stored thereon which are executable by a processor to perform functions described herein. In one embodiment, the instructions perform functions including presenting a story topic, and presenting a plurality of textual recording prompts to elicit verbalization of story segments for story subtopics of the story topic. Further functions include presenting an animated avatar as a virtual audience for the user during at least part of the story recording. The functions further include storing the story segments, introducing a media production enhancement(s), and compiling the story segments and the media production enhancement(s) into a unitary story recording. The story recording may be electronically published to enable access to the unitary story recording by others.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an embodiment for facilitating user generation of audio productions;

FIGS. 2A-2D illustrate representative user interfaces of a mobile application for facilitating the creation of a story by the device user;

FIGS. 3A and 3B illustrate nested prompts to provide the user with more specific instructions, prompts or other guidance upon selecting a particular higher level prompt;

FIG. 4 depicts another embodiment for facilitating the recording of audio productions, where one or more media enhancements are applied to the resulting assembled story;

FIG. 5 illustrates a representative example of a story/audio platform, which facilitates sharing and distribution of created stories and other audio productions;

FIG. 6 is a flow diagram illustrating a representative technique for facilitating storytelling or other spoken audio productions;

FIG. 7 provides an example of a computer implementation of a method for facilitating storytelling or other spoken audio productions;

FIGS. 8 and 9 are flow diagram illustrating representative embodiments of manners for facilitating storytelling using an application; and

FIG. 10 depicts a representative computing system in which principles described herein may be implemented.

### DETAILED DESCRIPTION

In the following description, reference is made to the accompanying drawings that depict representative implementation examples. It is to be understood that other embodiments and implementations may be utilized, as structural and/or operational changes may be made without departing from the scope of the disclosure.

The disclosure is generally directed to guided audio productions. Techniques are disclosed that facilitate user creation of audio stories, narratives, podcasts, and/or other recordings. Some embodiments are directed to techniques for recording verbal audio segments, and compiling at least those verbal segments into a unitary recorded audio production. Prompts or other instructions may be used to guide the user through a plurality of the audio segments, which may assist the user in knowing what to record, provide for consistent story structure across users, and/or otherwise facilitate the creation or structure of the audio production. The discrete audio segments may be compiled into a single story or other audio production.

For example, techniques described herein may be utilized to assist a user in recording a story. Storytelling has long been used to pass down history, local lore, or other stories and anecdotes through successive generations. While people may generally record an audio story, a microphone and blank recording medium are rather uninviting to the typical person. An untrained storyteller may be reluctant to record a story with such an open-ended and undefined format, whether recorded for public dissemination, targeted delivery to friends, or even for personal archiving.

Embodiments described herein provide, among other things, a structure available to users via prompts or other segment implications. Such prompts or guides enable users to logically segment their story through an inviting interface. Among other things, this provides the users with the confidence and wherewithal to provide story segments, which can later be compiled into a resulting story. Representative embodiments are described below.

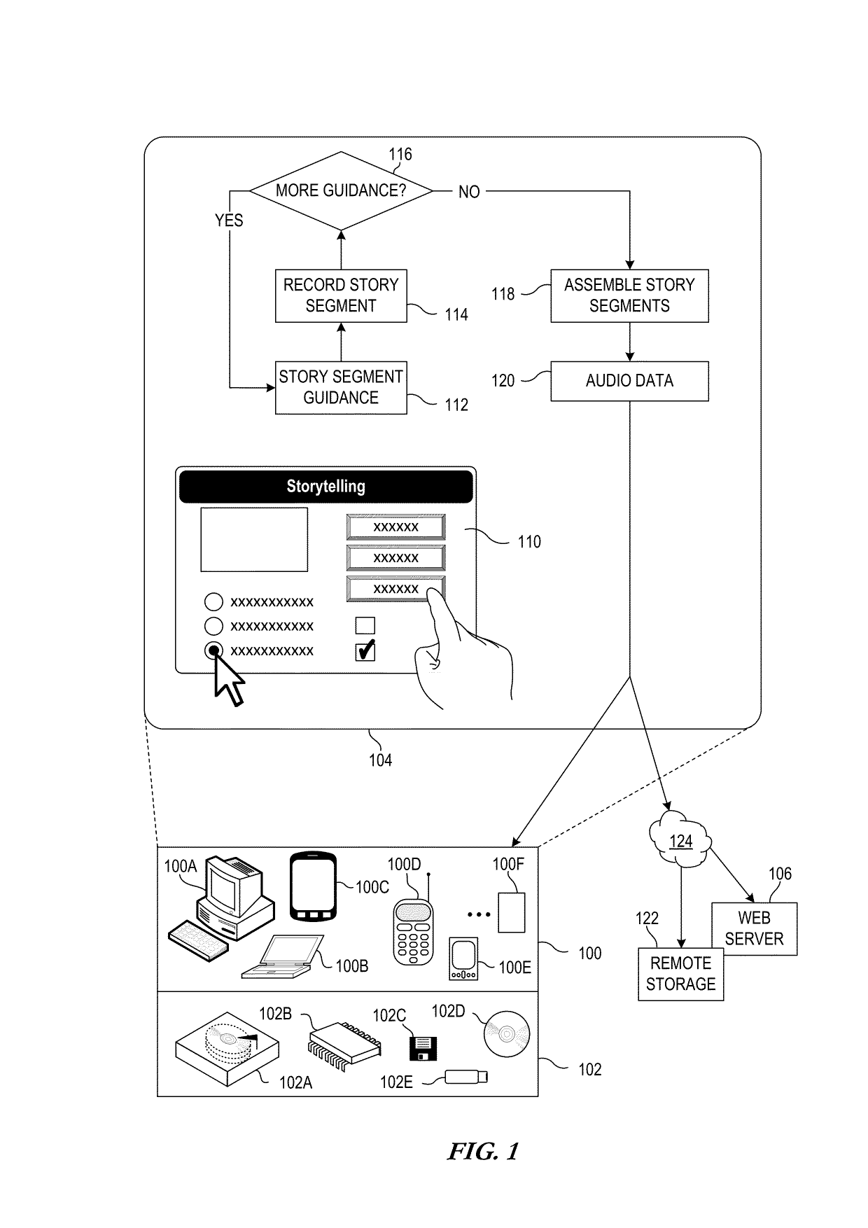

FIG. 1 is a block diagram of one embodiment for facilitating user generation of audio productions. It is first noted that the techniques described herein may be implemented in a user/client device, such as a desktop computer, portable computer, smartphone or other mobile phone/device, etc. In other embodiments, the application(s) may be provided to users by way of a remote service, such as one or more servers accessible to client devices by one or more networks. Some embodiments involve one or more remote servers, and appropriate storage facilities, to serve as a story platform or other audio platform whereby resulting audio productions may be accessed, embedded, rated, searched and/or otherwise utilized by devices capable of interacting with such a platform. In yet other embodiments, functions described herein may be distributed between local and remote devices. For purposes of example, the embodiment of FIG. 1 is described in terms of an application that is locally stored at a user device, or made available to user device via a server or other service available over one or more networks.

In the example of FIG. 1, the local user device 100 or apparatus may represent any type of computing device, such as a desktop computer 100A, laptop or other portable computer 100B, smart phone 100C or mother mobile phone 100D, personal digital assistant 100E, or other electronic device 100F. The user device 100 may store program code/software, firmware, data and/or other digital information involved in the facilitated audio generation processes described herein. Representative types of storage/memory 102 usable in connection with user devices 100 include, but are not limited to, hard disks 102A, solid state devices 102B, removable magnetic media 102C, fixed or removable optical media 102D, removable solid state devices 102E (e.g. FLASH), and/or other storage media. As an example, code and data may be permanently or temporarily stored on hard disks 102A and memory on solid state devices 102B.

The user device 100 may include a processor(s) (not shown) and/or other circuitry capable of executing software applications. Application 104 represents software executable by a processor(s) to present manners for guiding a user through the process of creating a story or other audio production. Additionally, processing and user interface functions may be hosted on a remote device, such as a web-based server 106 or other network-accessible system. For example, a web-based server 106 accessible via one or more networks 108 may perform the functions and host the relevant user interface mechanisms for display on the client device 100. In the illustrated embodiment, however, it is assumed that the processing and user interface functions are provided locally.

The application 104 may be responsible for causing one or more user interfaces 110 to be presented on the user device 100. The user interface 110 may guide the user through a process of creating audio data representing an audio production. For example, the user interface 110 operating under the control of the processor-executed application 104 may provide story segment guidance 112. The story segment guidance 112 may be, for example, an instruction, prompt, suggestive question, and/or other information that assists the storyteller in knowing what to speak. In response, the device 100 records 114 a story segment spoken by the user.

In one embodiment, the multiple prompts or other guidance are provided, to focus the speaker on particular parts of the story or other audio production. For example, the story segment guidance 112 may pose a question to the user, to which the user can verbally respond, thereby enabling the device 100 to record 114 that story segment. If additional prompts or guidance is available as determined at block 116, processing returns to provide the next story segment guidance 112. This may continue until a story segment has been recorded 114 for each prompt, at which time the story segments may be compiled or otherwise assembled 118. At least one result of this assembly is audio data 120, such as an audio file, streamed audio data, or the like.

The audio data 120, such as a spoken story, may be stored at the device 100, such as in any storage/memory 102. In another embodiment, the audio data 120 may be stored at a remote storage 122, such as storage associated with a web server 106 available via one or more networks 124. In one embodiment, storing the audio data 120 remotely, such as at the remote storage 122, enables other users to retrieve and listen to stories and/or other audio productions from the remote storage 122.

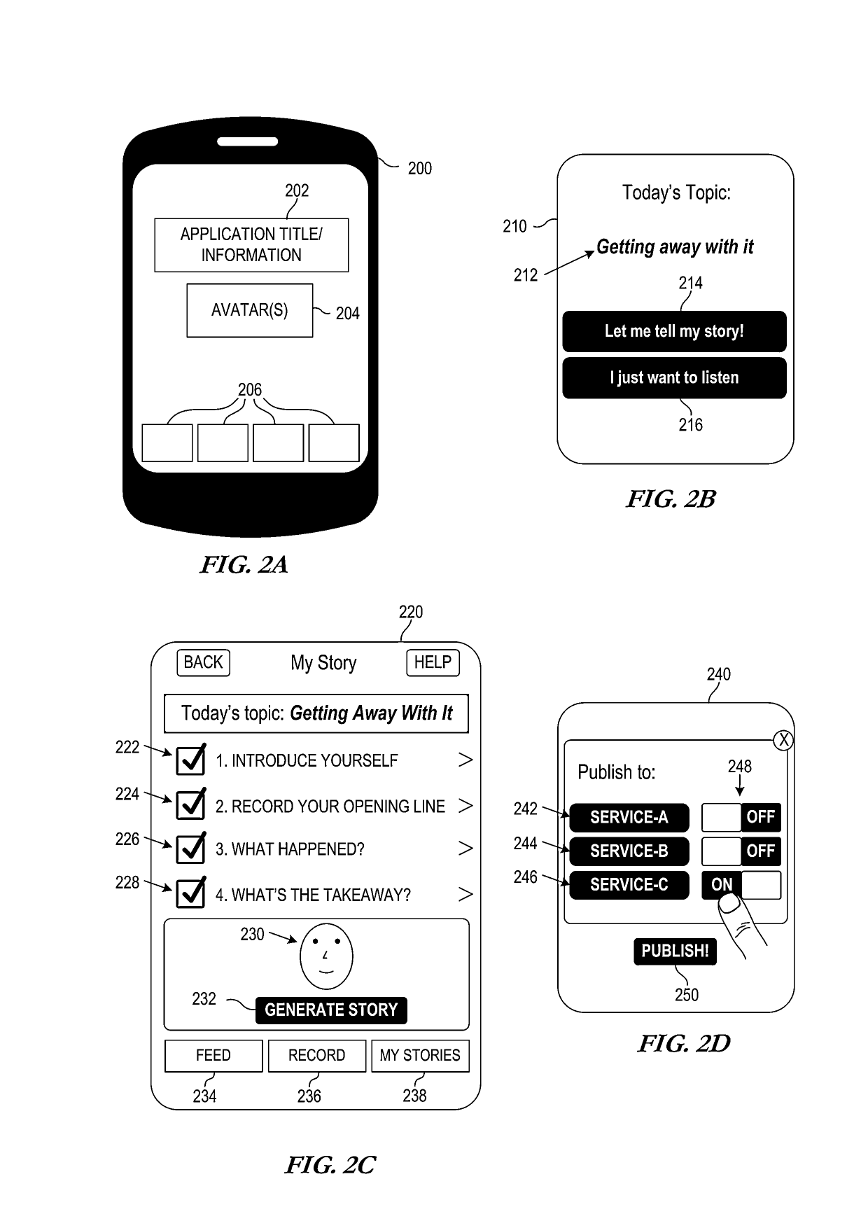

Thus, a storytelling or other audio production application may be provided to enable a user to create radio podcasts or other recordings to retain, share with friends/family, share with a community of listeners, etc. In one embodiment, the audio production application is a mobile application capable of executing on a mobile device, such as a smart phone, mobile phone or other mobile device. FIGS. 2A-2D illustrate representative user interfaces of a mobile application for facilitating the creation of a story by the device user. FIG. 2A depicts a mobile device 200 on which a mobile storytelling (or other audio) application may be executed. When the application 200 has been invoked, initial information may be presented such as an application title 202, avatars 204 or other images, control mechanisms 206, etc. The control mechanisms 206 may be, for example, touch sensitive buttons enabling the user to listen to other people's stories, initiate recording a new story, access the user's previously stored recordings, etc.

The user may select a control mechanism 206 or otherwise be presented with the user interface (UI) screen 210, as shown in FIG. 2B. In the illustrated embodiment, UI screen 210 presents a topic of the day indicated by some indicia 212. For example, a topic may be presented in text to notify the user of a story of the day. In other embodiments, the user may record any story associated with any topic, may receive topics from friends or family, etc. A UI item 214 may be provided to enable the user to initiate telling his/her story, while other UI items 216 may be provided to enable the user to listen to other people's stories.

For purposes of example, assume the user selected the UI item 214 to enable the user to initiate the audio recording and audio facilitation features. An example is depicted at FIG. 2C, where UI screen 220 includes multiple textual prompts 222, 224, 226, 228. Each of the representative prompts 222, 224, 226, 228 provides information to assist the storyteller in knowing what to say for that part of the story. In various examples the prompts, such as prompts 222-228, can represent instructions and/or requests for responses from the user. For example, the first prompt 222 in the illustrated example is a prompt for the user to introduce himself/herself. By selecting this prompt 222, the user can record a response. In one embodiment, avatar 230 and/or other visual presentation may appear to present the prompt 222. For example, avatar 230 can appear to say words relating to introducing yourself, such as “what is your name, and where do you live?” In another embodiment, selecting the prompt 222 presents one or more additional instructions, guides, or prompts to further assist the user in determining what information to record for that portion of the story. When the user has completed recording a portion of the story corresponding to the prompts 222, the prompts 222 may be denoted as completed, such as by providing a check mark proximate the prompt 222.

In the illustrated embodiment of FIG. 2C, for prompts 222, 224, 226, 228 are depicted, although any number may be utilized. Prompt 224 in the illustrated embodiment invites the user to record an opening line for the story. Selecting the prompts 224 may, in some embodiments, present further instructions, guides, prompts and/or other information to further assist the storyteller. Other prompts such as prompt 226 inviting the user to describe what happened, and prompt 228 asking for what the user believes is the takeaway of the story may also be provided. By recording responses to the respective prompts 222-228, the storyteller is essentially guided through the verbal presentation of the story. Among other things, this creates for at least some level of uniformity between stories of different users on that topic, as well as helps to notify the storyteller of potentially relevant portions of the story and structurally where they may lie in the story.

In one embodiment, one or more avatars 230 interact with the user in one or more manners. For example, as previously noted, an avatar 230 may present the prompts 222, 224, 226, 228. As another example, an avatar 230 can serve as an audience to the storyteller as the story segments are being spoken. In such an example, avatar 230 can create the sense that somebody is actually listening to the storyteller. Further, the avatar 230 may present a virtual microphone towards the user when the recording function is activated to more clearly remind the storyteller when in recording mode. The “audience” avatar 230 can also interact in other manners, such as by applauding an appropriate times, show emotions and/or expressions based on words, inflections or other input by the user. The avatar(s) 230 may be a default animation provided by the application, or could be a modifiable avatar. For example, the user may customize the avatar 230 to his/her liking, associate an actual image with the avatar 230 such as the image of a person known to the storyteller, etc. Thus, the avatar 230 may facilitate the storytelling by interacting with the storyteller in various manners.

When the various recording segments have been created, the recorded story segments may be compiled into a unitary story or other audio production. For example, in the illustrated embodiment, the user can touch, click on, or otherwise select the “generate story” UI item 232. This causes each of the recorded audio/story segments to be chronologically aggregated into the resulting story. As described in greater detail below, enhancements such as music, sound effects, images, locations, textual or audio annotations, and/or other information may be introduced into the resulting story. For example, musical interludes may be played between each of the recorded story segments, and an image of the storyteller may be presented with the resulting story.

Thus, by initially enabling the user to segment his/hers story into portions responsive to a plurality of story prompts, the structured format avoids an open-ended and potentially erratic storyline. Additionally, where multiple users are presented with the same prompts 222-228 for the common topic, analytics may be applied to any one or more of the recorded segments for a particular prompt. For example, user responses to a particular one of the prompts, such as “were you happy with the election results,” or “what is your favorite color,” could be analyzed and presented in one of a variety of different formats. Additionally, the responses to any one or more of the prompts could be rated or ranked by other listeners, and the highest ranked responses could be made available for listening, could win awards, etc.

In another embodiment, the topic and/or prompts 222-228 could be provided by the storyteller himself/herself, from family or friends (e.g. friends on a social network), or from random users of the storytelling application. Thus, while the example of FIG. 2C assumes that the application or remote service provided the topic and associated questions or prompts, the user and/or other users in the storytelling application community may also provide this information.

In FIG. 2C, three different control mechanisms are depicted as examples. A first control mechanism is the “feed” UI mechanism 234. The feed is used for providing users of the application with updated content, such as stories and/or other audio productions from other users of the application, or from a platform or remote storage configured to store the audio data for the users. In the latter case, a platform or remote storage environment can collect stories from application users, and disseminate them to others affiliated with the platform/remote storage.

For example, selecting the feed UI mechanism 234 can present the user with content (e.g. audio stories) from other users. In one embodiment, the feed content may be filtered, sorted, rated and/or otherwise manipulated to enable the application user listen locate and/or act on certain feeds. For example, a user can filter other stories by most recently published, top rated stories, favorite people the user is following, best friends, family, friends on a social network, etc. Another sorting feature for story feeds is a location-based sort. For example, a user of the application can tag a location in which to “drop” a story, and other users in that area can sort by location to find stories from a geographic location. For example, users can tag stories with a location at a famous landmark, and other users can listen to find stories tagged with that location.

In one embodiment, if the user selects a feed story, additional details may be provided about that story. The user can rate stories, provide textual or audio comment to stories, and/or associate other metadata therewith. Users having high rated stories may enable the highly-rated storytellers to receive “awards,” or otherwise be involved in competitions, leaderboards, featured storytellers, etc.

When the user is listening to another story obtained via the feed UI mechanism 234 or otherwise, the UI screen 220 may change to present UI items to facilitate listening. For example, rewind, forward, pause and other features may be presented. In one embodiment, the avatar 230 may correspond to an avatar of the author of a story when that author's story is being listened to by the user. For example, the author of the story could use a picture of herself that is used on the avatar 230, and when another user plays that story back, the authors “playback avatar” is presented on the screen to mimic the author herself telling the story.

Other UI mechanisms include the record mechanism 236, which initiates a recording function when activated by the user. Such a record mechanism 236 may also, or additionally, be presented when the user has selected a prompt 222, 224, 226, 228, and/or in connection with nested prompts. Another UI mechanism 238 can provide access to the user's own previously recorded stories. Thus, where the “feed” UI mechanism 238 provides user access to other users' stories, the “my stories” UI mechanism 238 provides user access to the user's own stories.

As noted above, the user may access other users' stories using, for example, the feed UI mechanism 234. When recording a story, the user can publish his/her story, so that other users can access his/her story by their own feed readers. FIG. 2D depicts a UI screen 240 enabling the user to publish stories for consumption by others. For example, one or more social networks, platforms, blogs, or other services may be listed, as depicted by service UI mechanisms service-A 242, service-B 244 and service-C 246. A UI mechanism 248 may be used to indicate which one or more, if any, of such services the user's story will be published to. In the illustrated example, the user has opted to publish the story to service-C 246, as depicted by the “on” state of the UI mechanism 248 associated therewith. The user can select the publish UI mechanism 250 to effect the publication of the story to the identified service(s). The user may also have the ability to email or otherwise directly communicate stories to targeted recipients.

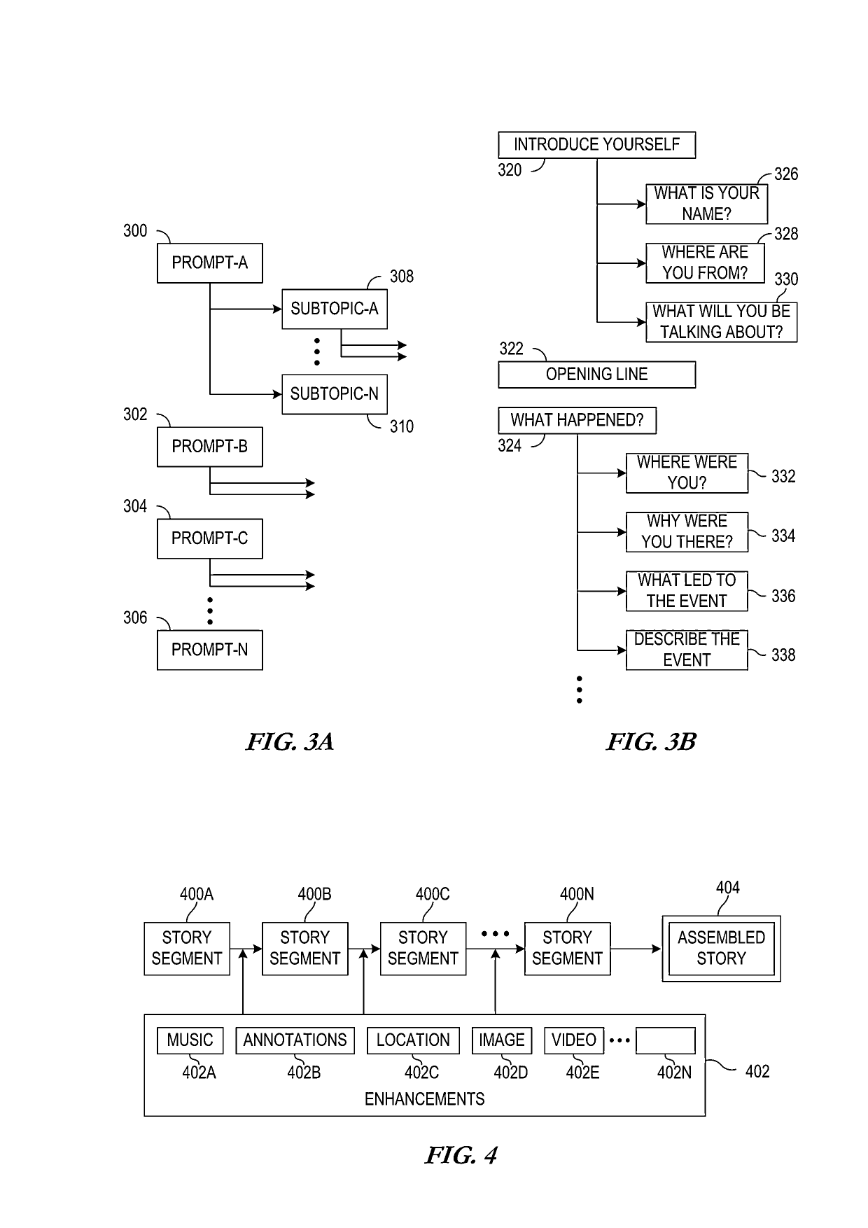

Prompts or other guides can assist the user in creating a well-structured story. In some embodiments, such guidance can involve multi-level prompts. FIGS. 3A and 3B illustrate nested prompts to provide the user with more specific instructions, prompts or other guidance upon selecting a particular higher level prompt. While some embodiments may involve one level of prompts, embodiments such as that depicted by FIGS. 3A and 3B illustrate that facilitating creation of a story through presented guidance can be provided at various degrees of specificity.

More particularly, FIG. 3A depicts a first level of prompts, labeled prompt-A 300, prompt-B 302, prompt-C 304 through prompt-D 306. While the prompt itself may provide instructions, in some embodiments the user can select the prompt to provide more specific guidance, or in some cases additional nested prompts. In the example of FIG. 3A, where the user selects prompt-A 300, a plurality of additional prompts are provided, depicted as subtopic-A 308 through subtopic-And 310. In other embodiments, still further nested instructions may be associated with any of the subtopics.

FIG. 3B illustrates a more particular example. In this example, the main level prompts include at least a prompt 320 to introduce the speaker, a prompt 322 to provide an opening line, and a prompt 324 to describe what happened. In this example, selection of the prompt 320 presents nested subtopic prompts, including subtopic prompt 326 asking for the speaker's name, subtopic prompt 328 asking where the speaker is from, and subtopic prompt 330 asking the speaker to state what he/she will be talking about. Prompt 322 includes no nested subtopics in this example, although prompt 324 includes multiple subtopic prompts. More particularly, subtopic prompts 332, 334, 336 and 338 serve as more specific prompts under the higher level prompt 324 that prompts the user to describe what happened. Using prompts, instructions and/or other guidance in this way enables the storyteller to fashion the story in a more structured manner, and also enables particular responses to any of the prompts 320-338 to be reviewed, compared or otherwise analyzed independently of the aggregate story.

FIG. 4 depicts another embodiment for facilitating the recording of audio productions, where one or more media enhancements are applied to the resulting assembled story. In this example, a plurality of story segments 400A, 400B, 400C through 400N are recorded by the user in response to particular prompts or other guidance as described above. Various enhancements 402 may be applied to the story segments 400A, 400B, 400C, 400N to augment the resulting assembled story 404. For example, one enhancement 402 is music 402A or other sound effects, that can be applied to be heard in parallel with one or more story segments, between story segments, etc. In one embodiment, music 402A fades in and out between story segments, such as between story segment 400A and 400B, and between story segment 400B and 400C, etc. Music may be provided by the service, selected by the user, selected randomly, etc.

Another representative enhancement 402 involves annotations 402B, such as textual or audio annotations that can be listened to if desired in connection with one or more of the story segments. Location 402C enhancements may also be applied to story segments 400A, 400B, 400C, 400N, or to the assembled story 404 as a whole. Image 402D or video 402E may similarly be applied to story segments 400A, 400B, 400C, 400N, or to the assembled story 404 as a whole. In one embodiment, an image 402D is applied to the assembled story 404 to be presented during the time that an audio story is being played back. In another embodiment, a plurality of images may be applied in a slideshow fashion. In still other embodiments, one or more enhancements 402 may be provided in parallel with portions of the story for particular times, during particular parts of the story, in response to events (e.g. change of story segment), or the like. Other enhancements 402N may also be utilized in connection with the techniques described herein.

While the enhancements may be applied at any desired time, in one embodiment the enhancements 402 are applied when the story segments 400A, 400B, 400C, 400N are being compiled into the assembled story 404. In one particular embodiment, the ability to add enhancements 402 is made available when such a compilation is made available, such as upon selection of the “generate story” UI mechanism 232 of FIG. 2C. One or more enhancements 402 may be added to provide a richer story, such as enabling the user to add any one or more of naming the story, adding music and/or sound effects, adding a picture(s), adding annotations, etc.

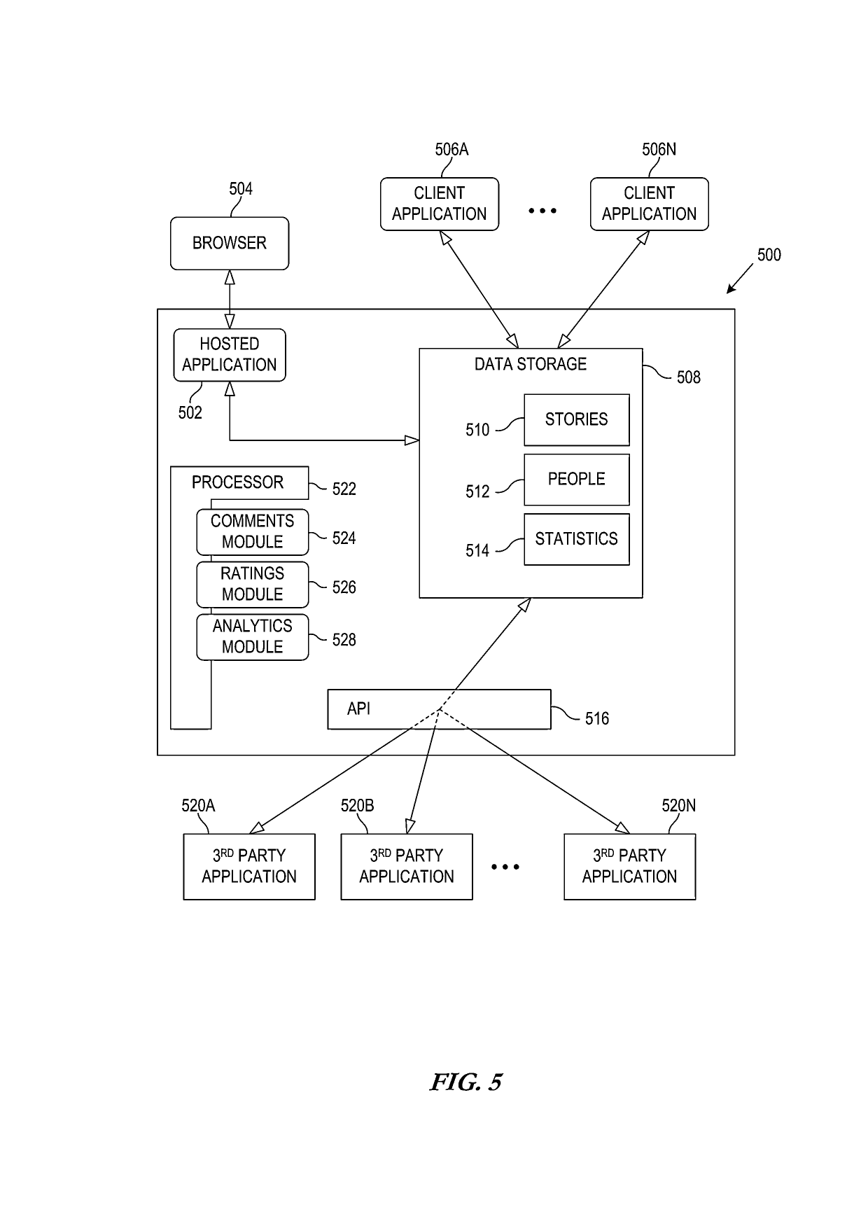

The techniques described herein may be applied in connection with a network-accessible story/audio platform that may include servers, storage, and other hardware. FIG. 5 illustrates a representative example of such a platform 500, which facilitates sharing and distribution of created stories and other audio productions. In one embodiment, the platform 500 itself can provide a hosted application 502, from which users can access the application via a browser 504 or other means. In other embodiments, users implement local client applications 506A, 506N that are capable of communicating with the platform 500. The platform 500 may be accessible to user devices by way of one or more networks, including local networks, large-scale networks such as the Internet, cellular networks, etc.

The platform 500 may include data storage 508 for data provided by or otherwise associated with the various users of the storytelling or other audio production application. Data storage 508 may store data including users' stories 510, identification of people 512 such as application users, statistics 514, etc. The stories 510 may be distributed in many ways, and may be pushed in many different kinds of platforms. Stories 510 stored at the platform 500 may not only be provided to users via the storytelling application, but may also (or alternatively) be provided to other users and other applications and platforms. For example, stories 510 could be pushed to other platforms such as gaming platforms, business software platforms, marketing platforms, etc. If such other platforms or services have a feed, a new content item, the “stories” described herein, may be provided to those feeds.

Therefore, the platform 500 may be provided as a set of tools having infrastructure to support client applications 506A, 506N, while also providing functionality such as an application programming interface(s) (API) 516 for the third parties to integrate with their own applications 520A, 520B, 520N.

For example, this could include testimonials gathered on a marketing website. One example is that a company may have a new product advertised on a third party marketing website. Users' stories relating to the new product may be stored as stories 510. A third party, such as 3^{rd} party application 520A, can obtain stories relating to the new product. The “stories” may be, for example, user experiences, user reviews, etc.

By aggregating stories 510 at a service or platform 500, still other functionality may be provided. Listeners of stories may add text or audio comments to other stories, which may be stored with the stories 510 for consumption by others listening to those commented stories. A comments module 524 may be provided, which may be software executable via a processor 522, to associate and/or store comments with respective stories 510.

In other embodiments, the platform 500 may facilitate user ratings of stored stories 510. Users can rate their favorite stories, and in one embodiment the top-rated stories could be presented according to rating. A ratings module 526 may be provided to perform such functions. In another embodiment, an analytics module 528 may be provided to analyze stories 510, or in other embodiments to analyze story segments provided in response to one or more prompts or other user guides. For example, the analytics module 528 could take all the answers to a third story prompt. A random sampling of a number of people's response can be presented as a group of audio segments for users to hear the variety of responses to a story prompt provided to a plurality of people. Ratings could then be applied to those story segments rather than the entire stories 510. Other modules may also be provided to provide other functions, and those depicted in FIG. 5 are presented for purposes of example only.

Thus, in one embodiment of the server or platform 500, the processor 522 is configured to provide the story topics to the device users. In such an embodiment, the storage 508 stores at least the audio stories 510 relating to the story topic and recorded by the device users. The API 516 may be configured to enable access to the stored audio stories by third party applications 520A, 520B, 520N.

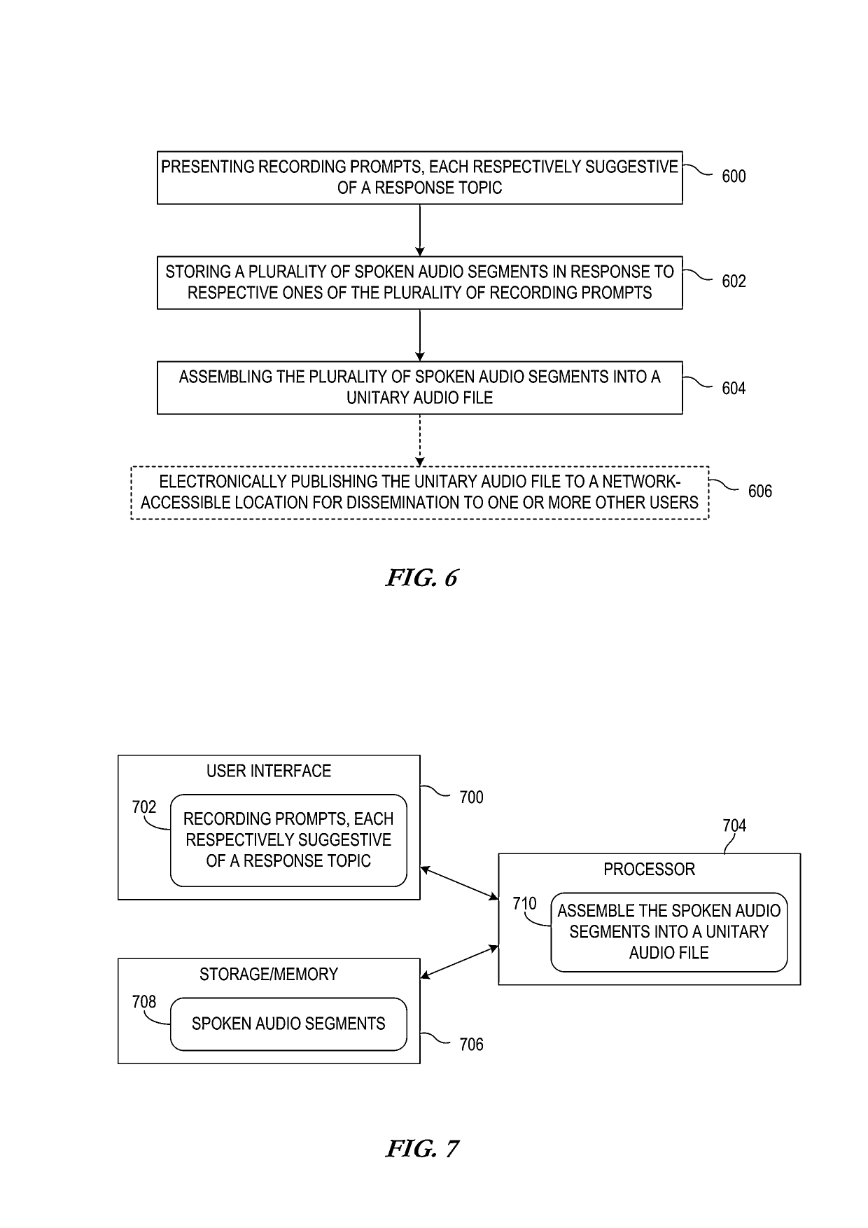

FIG. 6 is a flow diagram illustrating a representative technique for facilitating storytelling or other spoken audio productions. In this embodiment, the method involves presenting recording prompts, each respectively suggestive of a response topic as shown at block 600. Spoken audio segments, presented in response to respective ones of the plurality of recording prompts, are stored as shown at block 602. As depicted at block 604, the spoken audio segments are assembled into a unitary audio file. In another embodiment, the method may additionally involve electronically publishing the unitary audio file to a network-accessible location for dissemination to one or more other users.

The technique of FIG. 6 may be implemented via a computer or other processor-based machine. FIG. 7 provides an example of a computer implementation of the method described in connection with FIG. 6. In this example, a user interface 700 is configured to record prompts, each respectively suggestive of a response topic, as depicted at module 702. In one embodiment, a processor 704 executes software to provide the functionality of module 702. A storage/memory 706 is configured to store spoken audio segments 708 in response to the user speaking the audio segments in response to the recording prompts presented via the user interface 700. The processor 704 may include software to facilitate storing of the spoken audio segments 708 at the storage/memory 706. The processor 704 may further be configured to assemble the spoken audio segments into a unitary audio file as depicted at module 710.

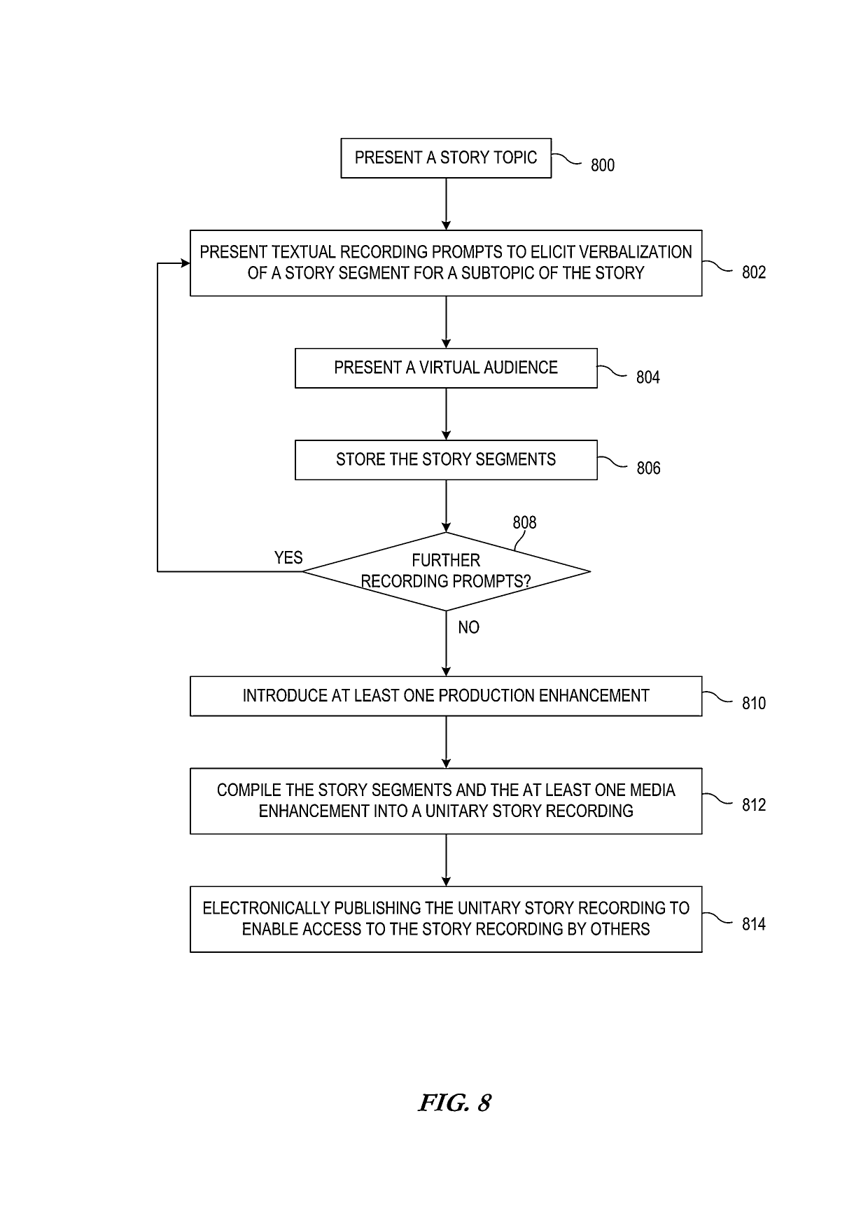

FIG. 8 is a flow diagram illustrating a representative embodiment of a manner for facilitating storytelling using an application. In this embodiment, a story topic is presented via the application as shown at block 800. At block 802, textual recording prompts are presented in order to elicit verbalization of a story segment for a subtopic of the story. A virtual audience is presented at block 804, such as presenting avatar and/or other images or video appearing to be responsive to the user. The verbalized the story segment is stored at block 806.

If further recording prompts are available as determined at block 808, processing returns to elicit further story segments which can be stored at block 806. When a story segment has been stored for all of the recording prompts, or at least for those story segments that the user wants to record, one or more media production enhancements may be introduced as depicted at block 810. At block 812, the story segments and the at least one media enhancement are compiled into a unitary story recording. In one embodiment, the unitary story recording is electronically published to enable access to the story recording by others.

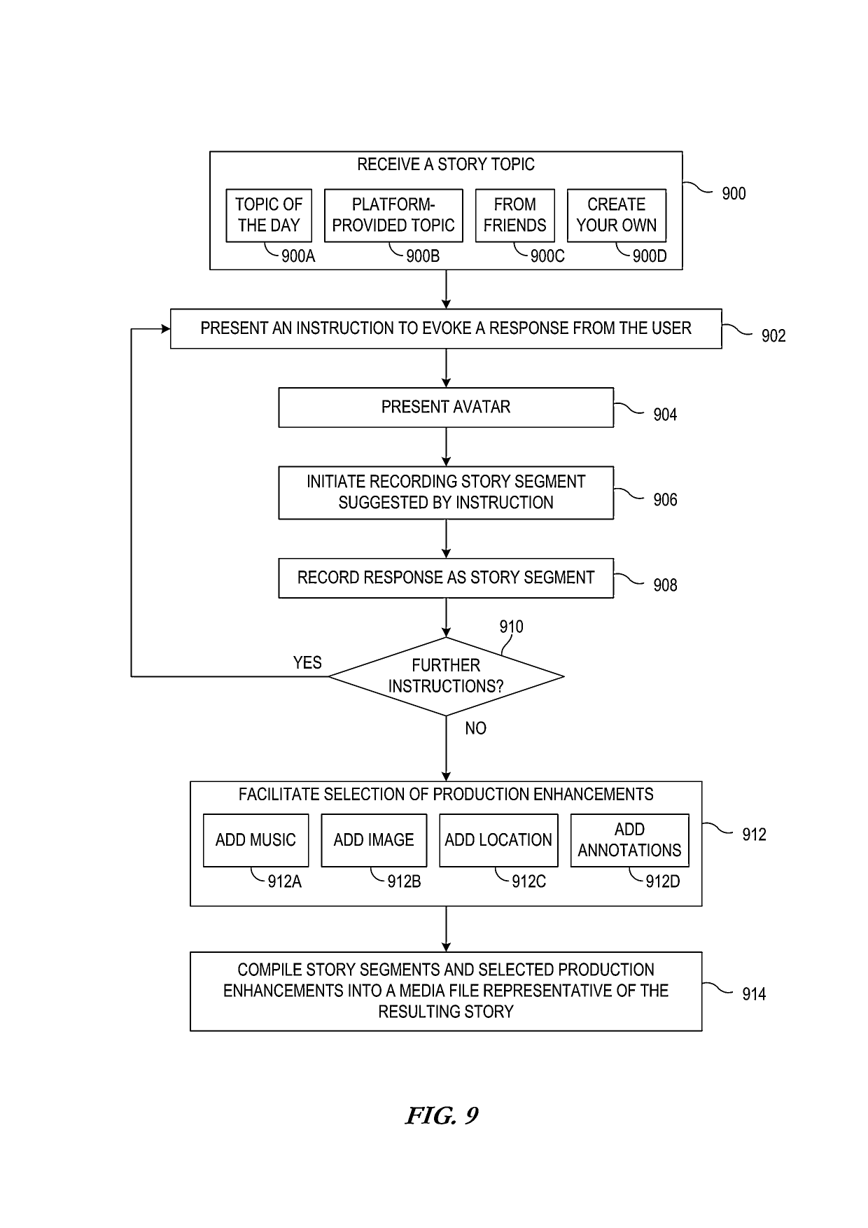

FIG. 9 is a flow diagram illustrating another representative embodiment of a manner for facilitating storytelling using an application. In this embodiment, a story topic is received at block 900. The story topic may be obtained by the application in any number of matters, such as receiving a topic of the day 900A from the application service, receiving a platform-provided topic 900B, receiving a topic from friends 900C, allowing the user to create his/her own topic 900D, etc.

In the embodiment of FIG. 9, and instruction is presented to evoke a response from the user as depicted at block 902. An avatar is presented to the user, as depicted at block 904. A recording story segment suggested by the presented instruction is initiated at block 906, and the responses recorded as a story segment as shown at block 908. If there are further instructions as determined at block 910, processing may return in order to ultimately record another response to the story segment at block 908 in response to another presented instruction from block 902.

When there are no further prompts/instructions, selection of one or more production enhancements is facilitated as depicted at block 912. Selection of production enhancements may include, for example, adding music 912A, adding one or more images 912B, adding one or more locations 912C associated with the recording, adding annotations 912D, or the like. The story segments and the selected production enhancements are compiled at block 914 into a media file that is representative of the resulting story.

As seen from the foregoing examples, the techniques described herein may be implemented in numerous embodiments. Among these various embodiments are the use of a mobile application for storytelling. Such an application may provide a topic of the day, and a structured question and answer format may lead to a good story by the user. A virtual avatar with emotive animations can provide the storyteller with some semblance of an audience response. The application of studio-quality production enhancements is supported, such as background music and sound mixing. Further, diverse media may be incorporated into the story, such as imagery, sensor data (e.g. global positioning system or other location data). As an example, this could take the form of a personal tour around a city, a richer vacation slideshow put together like a scrapbook, or audio commentary on exhibits at a museum. Stories can be based on locations (e.g. even a street corner) instead of just topics, as an enhanced “guest book”. Resulting stories may be published as podcasts, shared links on social networks, embedded in blogs or on websites, etc. The techniques support an embedding of the published story and the “topic of the day” into other websites. The storytelling experience may also allow for competitions, leaderboards, and featured storytellers, as stories of other users can be located and listened to. A platform may be provided as a set of tools to tell good stories, the backend infrastructure to support the client, and an API for third parties to integrate with their own applications. These exemplary embodiments are provided for purposes of example, and not of limitation.

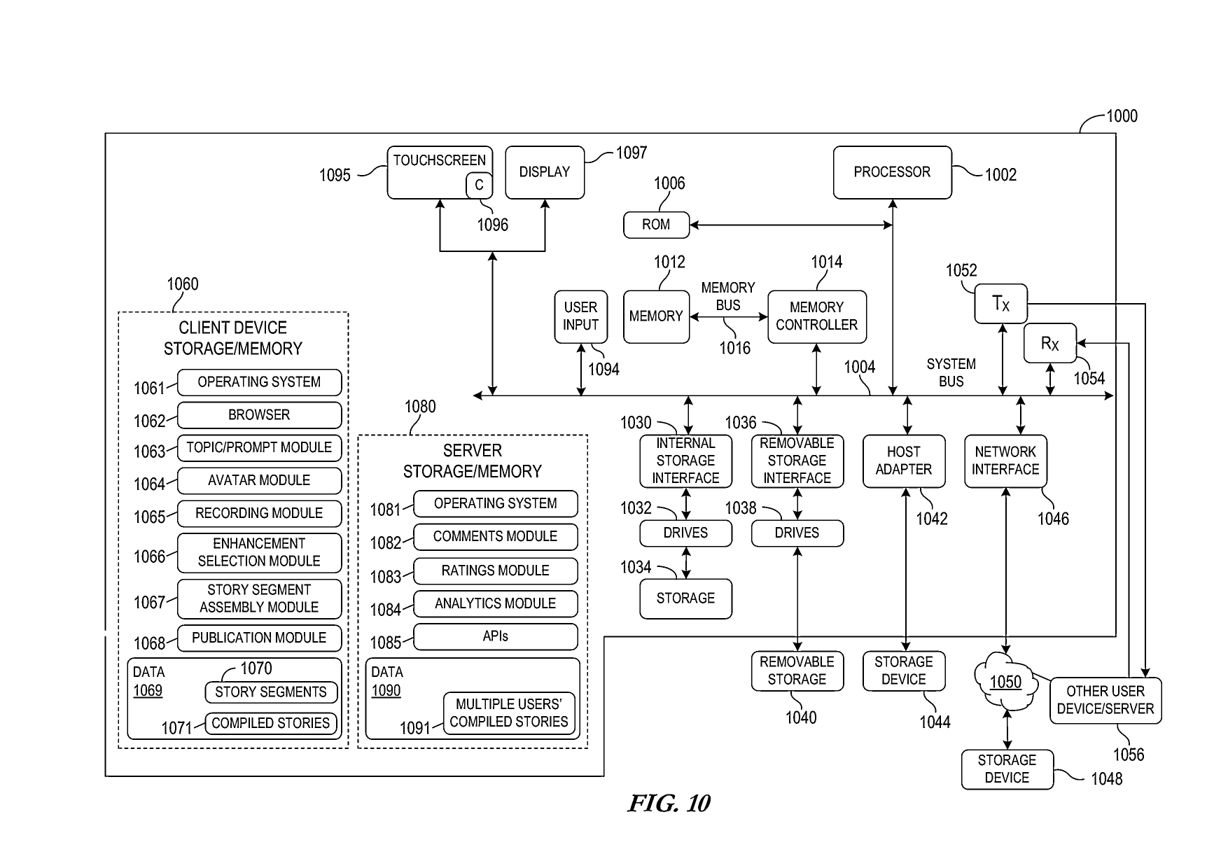

FIG. 10 depicts a representative computing system 1000 in which principles described herein may be implemented. The representative computing system 1000 can represent any of the computing/communication devices described herein, such as, for example, a client device capable of executing a storytelling application, web-based server or other platform hardware, etc. The computing environment described in connection with FIG. 10 is described for purposes of example, as the structural and operational disclosure for facilitating user generation of audio productions is applicable in any environment in which topic guidance and recording can be effected. It should also be noted that the computing arrangement of FIG. 10 may, in some embodiments, be distributed across multiple devices.

As noted above, functionality described herein may be implemented at a client device, or a remote device such as a server or other platform hardware. For both client devices and servers, the representative computing system 1000 may include a processor 1002 coupled to numerous modules via a system bus 1004. The depicted system bus 1004 represents any type of bus structure(s) that may be directly or indirectly coupled to the various components and modules of the computing environment. A read-only memory (ROM) 1006 may be provided to store, for example, firmware used by the processor 1002. The ROM 1006 represents any type of read-only memory, such as programmable ROM (PROM), erasable PROM (EPROM), or the like.

The host or system bus 1004 may be coupled to a memory controller 1014, which in turn is coupled to the memory 1012 via a memory bus 1016. The operational modules associated with the principles described herein may be stored in and/or utilize any storage, including volatile storage such as memory 1012, as well as non-volatile storage devices. FIG. 10 illustrates various other representative storage devices in which applications, modules, data and other information may be temporarily or permanently stored. For example, the system bus may be coupled to an internal storage interface 1030, which can be coupled to a drive(s) 1032 such as a hard drive. Storage 1034 is associated with or otherwise operable with the drives. Examples of such storage include hard disks and other magnetic or optical media, flash memory and other solid-state devices, etc. The internal storage interface 1030 may utilize any type of volatile or non-volatile storage.

Similarly, an interface 1036 for removable media may also be coupled to the bus 1004. Drives 1038 may be coupled to the removable storage interface 1036 to accept and act on removable storage 1040 such as, for example, floppy disks, compact-disk read-only memories (CD-ROMs), digital versatile discs (DVDs) and other optical disks or storage, subscriber identity modules (SIMs), wireless identification modules (WIMs), memory cards, flash memory, external hard disks, etc. In some cases, a host adaptor 1042 may be provided to access external storage 1044. For example, the host adaptor 1042 may interface with external storage devices via small computer system interface (SCSI), Fibre Channel, serial advanced technology attachment (SATA) or eSATA, and/or other analogous interfaces capable of connecting to external storage 1044. By way of a network interface 1046, still other remote storage may be accessible to the computing system 1000. For example, wired and wireless transceivers associated with the network interface 1046 enable communications with storage devices 1048 through one or more networks 1050. Storage devices 1048 may represent discrete storage devices, or storage associated with another computing system, server, etc. Communications with remote storage devices and systems may be accomplished via wired local area networks (LANs), wireless LANs, and/or larger networks including global area networks (GANs) such as the Internet.

User/client devices, servers, or other hardware devices can communicate information therebetween. For example, communication of recording prompts, recorded stories or story segments, media enhancements, and/or other data can be effected by direct wiring, peer-to-peer networks, local infrastructure-based networks (e.g., wired and/or wireless local area networks), off-site networks such as metropolitan area networks and other wide area networks, global area networks, etc. A transmitter 1052 and receiver 1054 are shown in FIG. 10 to depict the representative computing system's structural ability to transmit and/or receive data in any of these or other communication methodologies. The transmitter 1052 and/or receiver 1054 devices may be stand-alone components, may be integrated as a transceiver(s), may be integrated into or already-existing part of other communication devices such as the network interface 1046, etc.

As computing system 1000 can be implemented at a client device, server, etc., block 1056 represents the other devices/servers that communicate with the computing system 1000 when it represents one of the devices/servers. In addition to operating systems and other software/firmware that may be implemented in each of the user devices or message servers, each may include software modules operable by the processor 1002 executing instructions. Some representative modules for each of a number of representative devices/servers are described below.

When the computing system 1000 represents a user/client device, the client device storage/memory 1060 represents what may be stored in memory 1012, storage 1034, 1040, 1044, 1048, and/or other data retention devices of a client device such as a computer, smartphone, mobile phone, PDA, laptop computer, etc. The representative client device storage/memory 1060 may include an operating system 1061, and processor-implemented functions represented by functional modules. For example, a browser 1062 may be provided where the storytelling application is hosted by a server(s).

Other functions previously discussed in connection with the previous figures may also be provided as processor-executable modules in the storage/memory 1060 of the client device, such as a topic/prompt module 1063 that enables a topic to be presented, and obtained if applicable. The avatar module 1064 can present an avatar, and may provide the functionality to provide the appearance that the avatar is interacting with the user. A recording module 1065 can provide the executable software to cause the story segments 1070 and/or resulting stories 1071 to be stored, such as depicted in the data block 1069. An enhancement selection module 1066 may include software to enable the user to identify, select, incorporate, and/or otherwise utilize images, annotations, locations, music, sound effects, etc. The story segment assembly module 1067 is configured to concatenate story segments in their proper sequence, include any media enhancements, and create a final unitary audio file, stream, etc. A publication module 1068 may be provided to enable the user to publish or otherwise post stories to social networks, blogs, email, etc. The depicted modules are shown for purposes of illustration, and do not represent an exhaustive list of functional modules, nor are all of the depicted modules needed in various embodiments.

Where the representative computing system 1000 represents a server or other platform hardware, the memory 1012 and/or storage 1034, 1040, 1044, 1048 may be used to store programs and data used in connection with the server's functional operations. The server storage/memory 1080 represents what may be stored in memory 1012, storage 1034, 1040, 1044, 1048, databases, and/or other data retention devices at a storytelling server. The representative server storage/memory 1080 may include, for example, an operating system 1081. Where the server hosts a storytelling application, it may include any of the modules 1063-1068, and data 1069 previously described. When operating as a platform as described in connection with FIG. 5, various representative modules may include any one or more of a comments module 1082, ratings module 1083, analytics module 1084, APIs 1085, etc. Data 1090 may include, for example, stored compiled stories 1091 from multiple users of the storytelling application or platform. The modules described above may be implemented via software and/or firmware, and executed by the processor 1002 at the respective client/server device.

The computing system 1000 may include at least one user input 1094 or touch-based device to at least provide the user gesture that establishes the content navigation direction. A particular example of a user input 1094 mechanism is separately shown as a touchscreen 1095, which may utilize the processor 1002 and/or include its own processor or controller C 1096. The computing system 1000 may include at least one visual mechanism to present the prompts, avatars and/or other information, such as the display 1097.

As previously noted, the representative computing system 1000 in FIG. 10 is provided for purposes of example, as any computing device having processing and communication capabilities can carry out the functions described herein using the teachings described herein. It should also be noted that the sequence of various functions in the flow diagrams or other diagrams depicted herein need not be in the representative order that is depicted unless otherwise noted. As an example, presentation of an avatar may be presented at any time in the process, and not necessarily at the point in the representative flowcharts that it is presented.

As demonstrated in the foregoing examples, methods are described that can be executed on a computing device, such as by providing software modules that are executable via a processor (which includes a physical processor and/or logical processor, controller, etc.). The methods may also be stored on computer-readable media or other computer-readable storage that can be accessed and read by the processor and/or circuitry that prepares the information for processing via the processor. For example, the computer-readable media may include any digital storage technology, including memory 1012, storage 1034, 1040, 1044, 1048, any other volatile or non-volatile digital storage, etc. Having instructions stored on a computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained.

Although the subject matter has been described in language specific to structural features and/or methodological acts, it is to be understood that the subject matter defined in the appended claims is not necessarily limited to the specific features or acts described above. Rather, the specific features and acts described above are disclosed as representative forms of implementing the claims.

What is claimed is:

1. A computer-implemented method comprising:
presenting, via a user interface, a plurality of recording prompts each suggestive of a response topic;
storing a plurality of spoken audio segments in response to respective ones of the plurality of recording prompts; and
assembling, using a processor, the plurality of spoken audio segments into a unitary audio file.

2. The computer-implemented method of claim 1, further comprising electronically publishing the unitary audio file to a network-accessible location for dissemination to one or more other users.

3. The computer-implemented method of claim 1, further comprising introducing, using the user interface, one or more media production enhancements to create the unitary audio file having at least the plurality of spoken audio segments and the introduced one or more media production enhancements.

4. The computer-implemented method of claim 3, wherein introducing one or more media production enhancements comprises introducing at least one image to accompany the spoken audio segments when assembled into the unitary audio file.

5. The computer-implemented method of claim 3, wherein introducing one or more media production enhancements comprises introducing at least music between one or more of the spoken audio segments when assembled into the unitary audio file.

6. The computer-implemented method of claim 3, wherein introducing one or more media production enhancements comprises introducing at least a location to accompany the spoken audio segments when assembled into the unitary audio file.

7. The computer-implemented method of claim 1, wherein presenting a plurality of recording prompts comprises presenting a plurality of textual requests for responses.

8. The computer-implemented method of claim 1, wherein presenting a plurality of recording prompts comprises presenting a plurality of first level recording prompts, and presenting a plurality of second level recording prompts for one or more of the first level recording prompts.

9. The computer-implemented method of claim 1, further comprising distinguishing, using the processor, the spoken audio segments in the unitary audio file to facilitate remote analytics on a common one or more of the spoken audio segments from multiple users.

10. The computer-implemented method of claim 1, wherein the user interface and processor are implemented on a mobile device, and wherein the presenting, storing and assembling are governed by a software application executed by the processor.

11. The computer-implemented method of claim 1, further comprising presenting, via the user interface, a story topic, and wherein presenting the plurality of recording prompts comprises presenting multiple requests for responses to the response topics affiliated with the story topic.

12. The computer-implemented method of claim 1, further comprising presenting at least one visual avatar to serve as a virtual audience in connection with the spoken audio segments.

13. The computer-implemented method of claim 1, further comprising transferring the unitary audio file to a remote database for dissemination to other users.

14. The computer-implemented method of claim 1, further comprising one or more audio feeds to present audio files from other users.

15. An apparatus comprising:
a processor configured to provide story topics to device users;
storage configured to store at least audio stories relating to the story topic and recorded by the device users; and
an application programming interface configured to enable access to the stored audio stories by one or more third party applications.

16. The apparatus of claim 15, wherein the processor is further configured to facilitate association of comments for the stored audio stories.

17. The apparatus of claim 15, wherein the processor is further configured to calculate rankings of the stored stories based on ratings received from device users.

18. The apparatus of claim 15, wherein:
the processor is further configured to provide a plurality of subtopics to the device users, and to aggregate one or more audio story portions corresponding to the subtopics;
the storage is configured to store the one or more audio story portions; and
the application programming interface is configured to enable access to the one or more audio story portions by the one or more third party applications.

19. Computer-readable media having instructions stored thereon which are executable by a processor for performing functions comprising:
presenting a story topic;
presenting a plurality of textual recording prompts to elicit verbalization of story segments for a plurality of story subtopics of the story topic;
presenting an animated avatar as a virtual audience;
storing the story segments;
introducing at least one media production enhancement;
compiling the story segments and the at least one media production enhancement into a unitary story recording; and
electronically publishing the unitary story recording to enable access to the unitary story recording by others.

20. The computer-readable media as in claim 19, wherein the instructions for presenting the plurality of textual recording prompts comprise instructions for presenting multiple levels of recording prompts to provide more specific recording instructions in response to selection of a respective one of the textual recording prompts.
